(19) United States
(12) Patent Application Publication
(10) Pub. No.: US 2018/0151166 A1
(43) Pub. Date: May 31, 2018

(54) LOW FREQUENCY ACOUSTICS AND NEGATIVE STIFFNESS

(71) Applicant: Leib Morosow, Brooklyn, NY (US)

(72) Inventor: Leib Morosow, Brooklyn, NY (US)

(21) Appl. No.: 15/822,773

(22) Filed: Nov. 27, 2017

Related U.S. Application Data
(60) Provisional application No. 62/463,826, filed on Feb. 27, 2017.
(60) Provisional application No. 62/437,501, filed on Dec. 21, 2016.
(60) Provisional application No. 62/429,982, filed on Dec. 5, 2016.
(60) Provisional application No. 62/426,343, filed on Nov. 25, 2016.

(51) Int. Cl. G10K 11/162

(52) U.S. Cl. CPC G10K 11/162

(57) ABSTRACT

This application relates to improvements in low-frequency sound energy absorption, and low-frequency sound energy reflection, utilizing something termed “negative stiffness” which can be used to counteract—positive-stiffness in a body of air, making said body of air more compliant, and thus more responsive to the changing pressures inherent in sound waves. This application also includes a stiff, yet light, structure/mechanism, including a diaphragm held taut by an air pressure difference, for gathering low frequency sound energy from a large area and directing it into a much smaller area, thus allowing a tiny damper to do all the work of a very large one, and thus allowing for very affective inflatable bass traps and resonators, it also allows for a small mechanism, that may comprise springs, weights, dampers, and levers, to be used to easily, manually, or automatically, adjust the impedance, e.g. allowing frequency, as well as Q, adjustments in a resonator/bass-trap.

This application claims priority of provisional applications numbered: 62/463,826, 62/437,501, 62/429,982, 62/426,343.

### FIELD OF INVENTION

This application relates to objects designed to absorb and/or reflect low frequency sound.

### BACKGROUND OF INVENTION

### Regarding Absorbing Sound

Low frequency sound is very difficult to absorb because low frequency sound absorbers, like bass-traps, can only absorb energy that is temporarily stored in the contractions and expansions of a trapped body of air, this is why bass traps are commonly placed near walls and corners, because there the air pressures of the incident waves and reflected waves always support each other, resulting in greater air contractions and expansions. And since low frequency sound has fewer contractions and expansions it is harder to absorb, (so a larger sound wave requires a larger body of trapped air to match its size).

It can be compared to an electric circuit with a high impedance capacitor that limits the current flow in a wire and therefore limits the amount of energy a resistor in series with said capacitor may absorb, the capacitor's capacitance is analogues to the compliance in our trapped body of air, and the resistor is the damping mechanism. A common, but very limited, fix to this problem is to add mass, creating a—low frequency—resonator (this mass can also come in the form of a bottleneck/channel filled with air, as in a Helmholtz resonator, although it may be very little mass, it behaves as though it is a lot of mass due to the narrow channel).

Adding mass to a trapped body of air is like adding an inductor in series to our capacitor, this creates a circuit that will resonate at the frequency at which the inductor impedance fully cancels the capacitor impedance, and will also have a somewhat lower impedance at frequencies nearby where the inductor impedance and capacitor impedance only partially cancel each other.

Although adding mass can cancel the impedance resulting from lack of compliance (stiffness), it's only very affective for a very narrow bandwidth, so it would be much better if we could replace the air with something more compliant, but all gases are equally compliant, and volatile liquids, i.e. refrigerants, are way more trouble than they are worth, but what we can do is use negative stiffness to make the air appear more compliant. (Note that most references to “air” in this application, may also refer to other gases.)

### Regarding Negative Stiffness

Whereas—positive-stiffness is a force that increases as you move against it, negative stiffness is a force that decreases as you move against it, e.g. a tall heavy bookshelf leaning against a wall at a forty-five-degree angle, as you try to push it upright you find that, unlike a spring, the farther you push it the less it pushes back at you, that is negative stiffness. If this bookshelf only had one, narrow edged, leg to balance on, its negative stiffness function curve would approach a horizontal line (constant) as the bookshelf approached a vertical position, i.e. the force vector would very steadily shrink to zero and then reverse direction, this zero position occurs when the bookshelf is perfectly balanced on its one narrow leg, it can be seen from here that the zero position of a negatively stiff object has unstable equilibrium, whereas the zero position of a positively stiff object has stable equilibrium.

Since negative stiffness is simply a force that varies with position (stiffness =change in force divided by change in position), it can easily be recreated by combining a simple spring with a device that applies leverage that varies with position, e.g. noncircular gears will apply leverages that vary with position, so will a bookshelf, i.e. gravity has less leverage when the bookshelf is vertical, essentially any mechanism that has interconnected members that move at velocities that vary relative to each other (i.e. being none linearly related) will also result in varying leverages that are correlated to the inverse of these relative velocities, even the varying x and y velocity components of any single moving member can create varying leverage, e.g. a coaster slidably attached to a curved track, and connected to two tension members that are perpendicular to each other (one pulling it in the x direction, and the other pulling it in the y direction), as the angle (i.e. the x and y components) of the curved track, that the coaster is riding on, changes, so will the leverage ratio between the two tension members.

Such a coaster on a curved track can take practically any stiffness function curve (e.g. from a spring), and turn it into, practically, any other stiffness function curve, including a negative stiffness function curve.

Chinese patents CN104751836(A) and CN105551478(A) (published in 2015 and 2016) teach of devices that use attracting magnets to apply negative stiffness to a trapped body of air in an enclosure so that they can absorb more sound energy, they describe a hollow base, opened on one side, and a diaphragm covering the opening, effectively sealing the air inside, and a magnet (or magnets) in the base attracting a magnet (or magnets, or iron) on the diaphragm. (When it comes to audible frequency vibrations, magnets have some advantages over other mechanisms, because other mechanisms like the, above mentioned, coaster on a curved track need to be very small and light and may suffer from friction, wear, and noise.)

This patent application includes improvements to negative stiffness sound absorbers and/or reflectors, whether they use magnets, or other means of negative stiffness, e.g. leverage that varies with position.

### Regarding Blocking Sound

Besides being very difficult to absorb, low frequency sound is also difficult to block, i.e. fully reflect, because a wall that affectively blocks a sound wave must have a mass that is over a hundred times greater than the air mass that composes that sound wave, so that when the air mass of that sound wave hits the wall it will result in very little motion of the wall, and low frequency soundwaves have much more mass due to their large size, so only a very heavy wall can block them, another way to put this is, because the forces on the wall change direction less often when the frequency is low the wall has more time to accelerate and build up velocity, and when the wall has velocity and vibrates that causes the air on the other side of the wall to, also, vibrate.

Very heavy walls are not always possible, a partial solution to this problem is to create two walls with an air gap sandwiched between them, the compliance of the air in this gap serves to somewhat isolate these walls from each other (if there are points where these two walls are connected to each other, those connections should be springy, not rigid, otherwise the section of wall close to that connection won't be as affective at blocking the sound), The electric circuit analogy is that instead of using one very large inductor to block even the low frequencies, we use two inductors in series, and add a shunt capacitor between them, and the capacitor will divert some of the AC away from reaching the second inductor, the shunt capacitor represents, of course, the air gap.

Unfortunately, this air gap must often be prohibitively large, one way around this problem is to somehow make the air more compliant, thus requiring only a relatively small air gap to significantly isolate the two walls from each other, here, again, negative stiffness is the only practical solution. While highly compliant devices don't require walls to reflect low frequency sound, they do work better when combined with walls, because, their low impedance, and the walls high impedance, create an extreme impedance mismatch. They may also be very useful in muffling (absorbing and/or reflecting) engine noise, as well as in ductwork.

### Regarding Inflatables

Another issue that this application addresses is the fact that there exist no, cheap, high quality bass traps and resonators that allow for easy impedance optimization and/or are inflatable for storage and transport. These can be extremely useful at concerts, and the like, where very large bass-traps/resonators are needed for short periods of time. (Note that even a simple bass trap can benefit from impedance optimization, because to maximize energy absorption, the damping impedance should match the compliance impedance (reactance), and the compliance impedance is different for every frequency (as is made clear by the above analogy of a capacitor), besides, a good bass-trap should behave like a resonator with a very low Q).

### BRIEF SUMMARY

The detailed description, below, first describes how to design some of the very basic components that can be used by the devices described herein, e.g. how to design a hinge/pivot that doesn't make noise, and that won't wear out with use.

It then describes improvements relating to negative-stiffness-sound-absorbers-and-or-reflectors (hence forth referred to as negative stiffness devices or NSD) (similar to those described in the above mentioned Chinese patents). It then describes improvements to conventional bass-traps and/or resonators, these improvements may also be applicable to negative stiffness devices (NSDs) since they too can be thought of as bass-traps and resonators.

Improvements to negative stiffness devices (NSDs) (used to absorb and/or reflect low frequency sound), include a, slow acting, secondary mechanism for dealing with barometric (and altitude) and temperature changes which, in a highly compliant device, will cause large undesirable diaphragm displacements, that will coincide with relatively large undesirable internal pressures, and which will put a very large burden on the negative-stiffness elements (magnets).

Improvements to bass-traps and/or resonators include a stiff, yet light, structure/mechanism, including a diaphragm held taut by an air pressure difference, for gathering low frequency sound energy from a large area and directing it into a much smaller area, thus allowing a tiny damper to do all the work of a very large one, and thus allowing for very affective inflatable bass traps, resonators and NSDs, it also allows for a small mechanism, that may comprise springs, weights, dampers, and levers, and even negative-stiffness-elements (magnet pairs), to be used to easily, manually, or automatically, adjust the impedance, e.g. allowing frequency, as well as Q, adjustments in a resonator/NSD.

### DESCRIPTION OF DRAWING

FIG. 1. illustrates one, herein specified, embodiment of a bass-trap/resonator (NOT comprising negative stiffness), comprising an inflated sphere 11 that is stiff-against-tension, and a tension member assembly 12 connecting to the front of said sphere and to the back of said sphere, thus allowing said front and back, of said sphere, to act as, independent, vibrating diaphragms 19 when exposed to low frequency sound. A plurality of stiff-against-tension tension members, arranged in cone-shape formations 13 connects the tension member assembly 12 to the sphere 11. The tension member assembly 12, comprises a damper 14, and a primary spring 15, between two very stiff, curved, rods/levers 16, where the bottom ends of said rods/levers are in firm, and nonslip, contact with each other, and where the damping impedance of the diaphragms 19, can be adjusted by repositioning some of the force locations on said levers 16, it also comprises very stiff rods/levers 17 with dissimilar weights on each end, said rods/levers 17 can be repositioned by first loosening the stiff clamps that hold them, this will have the effect of altering the mass of the adjacent diaphragm 19. The tension member assembly 12, also comprises a secondary, much more compliant spring assembly 18, which comprises a spring-loaded wheel that pulls in the slack in the tension member assembly 12, resulting from barometric change and temperature change and slow air leaks, etc., where said spring-loaded wheel isn't nimble enough to respond to sound vibrations, because it's connected to a flywheel. The sphere sits on a base 20 that cradles its bottom for reasons explained later.

### DETAILED DESCRIPTION

### Prerequisite Specifications of Basic Components Utilized Herein

Most of the audible vibrations that most of the embodiments' members, specified herein, will be required to handle will probably be but a fraction of a millimeter in size, so any pivotally vibrating members (who's vibrations are manifested in a pivoting motion), that are more than a few millimeters long, will only require to pivot a few degrees or less, for this reason we can mostly do away with conventional hinges, because they create friction and noise, and replace them with members that can bend elastically, however we still need to worry about wear or fatigue, so the following are a few steps that can be taken to significantly reduce wear or fatigue on bending members e.g. keeping them under their fatigue limit.

Making bending members relatively long and thin will significantly reduce fatigue due to bending, exposing members to tension only (not to compression) will make such longer and thinner members possible, this means that vibrating members that experience forces (motions) in multiple (possibly opposing) directions may be required to be supported by multiple (possibly opposing) tension members. Note that said supporting tension members need to be stiff (i.e. not stretchable—but they are allowed to be bendable) so that they may transmit the sound vibrations, however whenever there are supporting tension members that oppose each other (i.e. pulling in opposite directions), only one of them needs to be stiff, the other one may even be a compliant spring, as long as it can supply enough force to keep the opposing tension member taut at all times, so that it may transmit the sound vibrations, this is an important point to remember when designing a system with stiff tension members because it allows for a lot more flexibility, e.g. it allows supported members to pivot in transverse directions.

Implementing strain relief techniques on bending members will help against fatigue too, e.g. like the way an electrical wire joins with its plug, i.e. by making the points on the wire that experience more bending force, harder to bend, e.g. by making them thicker, thus making the bend less sharp, and spreading out the bend over a larger area. Another technique is to position a curved surface adjacent (always touching) to the bending member, thus forcing said bending member to bend around said curved surface, thus again, spreading out the bend over a larger area, such a curved surface may even take the form of a flared sleeve around the bending member, thus allowing said bending member to safely bend in all directions.

Now that we know what our hinges/pivots may look like, we can specify a few very simple mechanisms that can utilize said hinges/pivots, these include a mechanism for transmitting vibrational energy—through tension members (wires)—around turns (note that because of the high stiffness to mass ratio, there are no breakaway energy waves, i.e. the entire system can be well within one quarter wavelength), these also include a mechanism that applies leverage (which can alter the impedance), as well as a mechanism that allows said leverage to be adjustable, either, manually, or automatically.

There are at least two simple ways to transmit vibrational energy, through (stiff) tension members (wires), around turns, one is by utilizing an L (or triangular) shaped lever, another is by utilizing a three-tension-member junction (resembling the letter Y), i.e. to design a bend into a tension member (wire), that transmits vibrations, without interfering with said vibration transmission, requires another tension member that spans from said bend, to an unvibratable (i.e. unmovable) member (said unmovable member may be unmovable either, because it has a lot of mass, or because it connects to a common, stiff, framework, where said framework, either experiences equal but opposite forces as well, or where said framework can be considered as the frame-of-reference against which all other motions can be measured, i.e. since we are mostly interested in motions involving the contractions/expansions of the device, i.e. the (sub millimeter) motion of one part of said device relative to another part of said device, and not in movement of said device relative to its surroundings, we can forgo any concept of absolute rest/motion—note that this definition of the term “unmovable/unvibratable” also applies to the fulcrum of the, above mentioned, L shaped lever, as well as to various other specifications herein).

A sharp bend i.e. a bend that is not very obtuse, can warp the sound vibrations if the tension members are not long enough, i.e. the angles will be continuously changing due to the vibrations, this will add harmonics to the sound. So multiple, very obtuse, bends (i.e. a series of three-tension-member junctions) can be used instead. Note that the parts of the tension members nearest said junction will be bending back and forth, slightly, with each vibration, so they should be treated as hinges/pivots as specified above.

There are, at least, two simple ways to apply leverage (perhaps to alter the impedance), one is by utilizing a (very stiff) lever, e.g. using a lever where all forces applied to said lever are by way of—bendable—tension members, another is by utilizing a three-tension-member junction (resembling the letter Y), i.e. if one of the three-tension-members (wires) is connected to an unmovable member then the leverage ratio between the two other tension members will depend on their angles relative to the unmovable (i.e. anchored to an unmovable member) tension member, i.e. the more perpendicular any tension member is to the unmovable (i.e. anchored) tension member, the more relative leverage it will have. Again, long tension members (i.e. many times longer than the vibration size, or the bends, in the tension members, that said vibrations create) will preserve the integrity of the vibrational signal, because it will result in smaller changes to said angles.

Both said techniques of applying leverage can also utilize techniques for making, manual or automatic, adjustments to said leverage, e.g. by utilizing a lever that has parts that can be made longer and shorter, thus resulting in leverage adjustments, e.g. where a part of said lever can pivot on a secondary pivot/hinge that is perpendicular to the main pivot/fulcrum (and who's axle is perpendicular to the lever as well), thus allowing parts of said lever to become operationally shorter and longer, resulting in leverage adjustments, (such a design may put significant perpendicular torque on both pivots, so designing longer pivots/hinges will help, i.e. hinges with longer axles will withstand/resist a greater perpendicular torque), (since the secondary hinge/pivot may not be pivoting with each vibration, but only when the leverage needs adjusting, it may possibly utilize a conventional hinge, but the fulcrum can use multiple long—bendable—tension members on both ends of its long axle), (note that most references to levers can apply to class a, class b, and class c levers).

Another way to make leverage adjustments is to utilize slidable clamps that can be repositioned along the lever, thus moving the fulcrum, or the other force points, on the lever.

Making, manual or automatic, leverage adjustments, when using three-tension-member junctions, can be as simple as moving the unmovable member, thus changing the angles between the tension members, thus effecting a leverage adjustment.

### Regarding Negative-Stiffness Devices

Negative stiffness devices (NSDs) (used to absorb and/or reflect low frequency sound) (similar to those described in the above mentioned Chinese patents) that are more than just twenty or thirty percent more compliant than regular air, will benefit greatly from a, relatively slow acting, secondary mechanism that acts to keep the negative-stiffness elements (magnets) within their operational (functional) range despite barometric (and altitude) and temperature changes which can cause large undesirable diaphragm displacements, that will coincide with relatively large undesirable pressures, internally, as well as on the negative-stiffness elements (which in the, above mentioned, Chinese patent embodiments, happen to be magnets—but they don't have to be).

E.g. a negative stiffness device (NSD) that has ninety percent of its internal air stiffness canceled by negative stiffness, will be ten times more compliant than air, and will have a volume change of, around, twenty percent in response to a two percent barometric shift, this corresponds to an eighteen percent shift in the internal relative air pressure, this will put a very high demand on the negative-stiffness elements (magnets). In contrast, air pressures resulting from a very loud 130 dB sound corresponds to less than one tenth of one percent of an atmosphere.

Such a, slow acting, secondary mechanism may also handle, slow, air leaks, however, note that even if the barometer and temperature are held constant and there are no air leaks in the device, this secondary mechanism will still be necessary in substantially compliant devices, because adiabatic air is stiffer than isothermal air, which means that the air will exhibit more stiffness in response to quick (adiabatic) pressure changes than it will to slow (isothermal) pressure changes, so the negative-stiffness elements that are designed to cancel most of the air's quick (adiabatic) stiffness will overwhelm the air's slow (isothermal) stiffness, causing the diaphragm to exhibit, slow, instability that require regular adjustments, very similar to the adjustments one needs to make when balancing a relatively long stick on their finger.

Thermally isolating, the air in the chamber, as much as possible, will make the system more stable, the equivalent of making said balanced stick, longer, so a radiation-reflecting layer enclosing some, or all, of said air, can help, and an insulation layer enclosing some, or all, of said air can help. It will help if the side of the insulation that is in contact with said air be very light so as not to transfer its own heat into said air.

Such a secondary mechanism may need to be active, i.e. have a power source, but considering that it can make a three cubic foot bass trap/resonator be as effective as a thirty cubic foot bass trap/resonator, and it can make a four inch, isolating, gap between two walls be as effective as a forty-inch gap, perhaps on aircrafts, can make it well worth it.

Such a secondary mechanism can run somewhat slowly so that it doesn't compensate for twenty Hz pressure changes as it does for a barometric change, but it may be beneficial if it runs continuously, because the longer it waits between corrections the more power it will consume, it may also be beneficial if the speed at which it runs depends on the size of the error needing correction, it may also be beneficial if the speed at which it runs can only change gradually.

There are many, possible, practical, slow-mechanism designs for keeping, low-force negative stiffness elements, within their functional range, despite slow, but forceful, events, like barometric change. Most of these mechanism designs will have various side effects, but most of these side effects will be good, like, keeping any diaphragm displacements within a functional range, some will affect not only the forces but also the stiffness, this, too, is advantages for maintaining a constant resonant frequency despite temperature, and barometer, changes.

Said mechanism should keep track of where within its functional range the negative stiffness element is, it can do so by, either, tracking the force on said element (perhaps by using a scale), or by tracking the length of said element (perhaps by using proximity sensors), said tracking method may also be very indirect, e.g. measuring, both, the external air pressure (barometer), and the internal air pressure, may be enough to know the force on the negative stiffness elements,

There are several, practical, general approaches for said mechanism, these can involve making direct adjustments to the trapped air inside the chamber, as well as, making direct adjustments to the solid matter that composes the chamber. Making direct adjustments to said air can involve adding/removing air to the trapped-air chamber (perhaps through the use of an automated air valve or pump), also, adding/removing heat can have the same effect, note that these actions will have a counterintuitive effect, e.g. adding air will create a pressure drop, because it will cause a disproportionately large outward movement of the diaphragm, and therefore a disproportionately large increase in chamber volume.

Making direct adjustments to the solid matter that composes the chamber can involve changing the size of the chamber, perhaps by moving one of its walls in and out, or by moving the fixed ends of the negative-stiffness elements (which, in the above Chinese patents, is the fixed magnet that is attached to the base) in and out (and since the negative stiffness elements are attached to the diaphragm and the diaphragm serves as one of the chamber walls, it is somewhat similar to moving a chamber wall in and out), note that said movements will have a counterintuitive effect, i.e. moving a chamber wall, or the fixed end of the negative stiffness element, inwards (as in trying to shrink the chamber) will cause an internal pressure drop, because it will cause the diaphragm to move significantly outwards, thus enlarging the chamber.

Making direct adjustments to the air alone (e.g. adding or removing air), when compensating for barometric change, can have a significant effect on the resonant frequency of a sensitive NSD, e.g. a slight increase in barometer will cause the diaphragm to move significantly inwards, so to compensate, an equally slight amount of air can be pumped into the chamber bringing the diaphragm, and therefore the negative stiffness elements, back into position, but now the internal air pressure is, still, slightly higher than before, and since for a gas of a given volume, pressure and stiffness are corelated, the internal air stiffness will be slightly higher as well, this difference may only be five percent, but after the negative stiffness cancels ninety percent of said air stiffness, this five percent will become fifty percent. So, to maintain a constant resonant frequency, as the barometer goes up, adjustments to the solid matter of the chamber can be made, e.g. that will result in a larger chamber, because a larger chamber, holding a larger body of air, is more compliant.

Another possible way of making direct adjustments to the, said, solid matter, can involve making leverage adjustments between the negative stiffness elements and the diaphragm, e.g. by utilizing tension members extending from the negative stiffness elements, and tension members extending from the diaphragm, it is possible to create a leverage adjusting mechanism as specified above.

Leverage adjustments affect stiffness (change in force divided by change in position) significantly more than they affect force itself, so it is possible to algebraically isolate stiffness by making leverage adjustments while simultaneously making adjustments that compensate for changing force. Such stiffness adjustments can control the resonant frequency.

When the negative stiffness element(s) and the diaphragm are connected through a lever, moving the fulcrum, of said lever, along a line that is parallel to the force vectors, is operationally equivalent to moving the fixed end of the negative stiffness element, i.e. it will have the same net effect, (note that most references to levers can apply to class a, class b, and class c levers).

Negative stiffness devices (NSDs) can, either, be designed with an air chamber who's pressure is always above atmosphere, or always below atmosphere, or around (sometimes above and sometimes below) atmosphere, the advantage of the former two is that the diaphragm can be light and flexible and still never lose its shape (because it's being supported be the air pressure difference), another advantage is that its negative-stiffness elements never need to cross the zero-force position, the advantage of the latter is that diaphragm adjustments alone, resulting from, automated, negative-stiffness element adjustments alone, can serve to force air, both, in, and out, of the chamber through tiny openings, thus allowing the diaphragm, as well as the negative stiffness elements, to stay within a very small range, despite slow air leaks and barometric changes etc.

So one embodiment of a negative stiffness device that includes advantages of all of the above embodiments, comprises an air chamber who's pressure is always above atmosphere, and where said air chamber is connected to a second, similarly pressurized, air chamber, by way of a very small opening that allows only a slow trickle of air between them, this second air chamber can serve as an air reservoir, but it won't affect the short term (20 Hz) air stiffness in the primary chamber, due to the very small opening between them, this secondary chamber may be expandable/contractible, perhaps utilizing a low-stiffness spring, it may also include an automatic pump to replenish any pressure drop over time.

One, said, secondary chamber may be shared by many negative-stiffness devices, e.g. a tube from said secondary chamber can connect to many nearby devices, and small openings, into every device, will limit the airflow. A shared secondary chamber can be very useful when many small negative-stiffness devices are positioned between wall surfaces/panels to form a, relatively light, wall that blocks low frequency sound (see explanation in BACKGROUND).

The diaphragms of the many negative-stiffness devices inside of said wall, may, or may not, be one with said wall surface/panel, for example if there are air gaps between said devices that need an outlet, then keeping the diaphragm separate from the wall will be beneficial, although half and half may also be an option.

One issue with the devices in the above mentioned Chinese patents is that negative stiffness is unstable, so the diaphragm attached to the movable magnet(s) will not want to maintain one angular orientation, i.e. the slightest unevenness in magnetic pull on different parts of the diaphragm will have a runaway effect causing the diaphragm to tilt unpredictably, in the least this will result in unpredictable harmonics, it may also result in magnet collisions.

A solution to said issue is not to allow the different magnetic parts, on the diaphragm, to move independently, for example the magnetic parts on the diaphragm may all be attached to a single rigid object that moves by tilting on a hinge, like a door, this will eliminate the instability and unpredictability, but the diaphragm will still tilt, so a simple mechanism that is commonly utilizes in reading lamps, that allows the lamp to be repositioned without causing it to simultaneously tilt, can be utilized here as well, (other techniques, using tension members that come together to a single point, are included below).

The English translation of said Chinese patents is not clear, but to create a negative-stiffness device that doesn't just reflect sound energy, but absorbs it, damping is necessary, and pretty much anything that absorbs sound, will absorb more sound when placed inside of a negative stiffness device's air chamber, this is because the sound level inside of a negative-stiffness device's air chamber is a lot more concentrated than it is outside, so more sound energy will be absorbed by anything that absorbs sound.

Other variations that the Chinese patents seem not to cover, and that I'd like to claim, is a negative stiffness device that absorbs sound and/or reflects sound away from itself, that uses a negative stiffness element that utilizes leverage ratios that change based on position, and/or that utilizes repelling magnets, Although the repulsive force of a magnet is not negatively stiff, it can result in negative stiffness through the use of leverage ratios that change based on position, i.e. arranging the magnets so that the direction of movement (which is a straight line), of the magnet that is connected to the diaphragm, is perpendicular to the fixed magnet's repelling force, will result in an operational force on the moving magnet that will increase as said magnet moves away from center (center being where said repelling force and said movement are perpendicular).

### Regarding Inflatables

A stiff, yet light, structure/mechanism, including/comprising a stiff (i.e. not stretchable, but possibly flexible) diaphragm held taut by an air pressure difference, can gather low frequency sound energy, that gets temporarily stored in the contractions and expansions of a relatively large, trapped, body of air, and direct it into a very small area, thus allowing a tiny damper to do all the work of a very large one, and thus allowing for inflatable, yet very effective, bass-traps, resonators and NSDs, it also allows for a small mechanism, that may comprise any of springs, weights, dampers, and levers, and even negative-stiffness-elements (magnet pairs), to be used to easily, manually, or automatically, adjust the impedance, e.g. allowing frequency, as well as Q, adjustments in a resonator/NSD.

A stiff structure can comprise relatively light weight materials that have a high young's modulus, e.g. aramid, said structure need not be all that stiff to function, but stiffer is better, especially in a resonator, or NSD, where the internal sound pressures are a lot greater than the outside ones. Using light-weight materials is good because it allows it to be made thicker and therefore stiffer. A stiff structure may utilize tension, instead of compression, when possible, but more importantly, it may avoid forces that try to force bending in a member/structure, when possible, it may borrow techniques from crane designs, and such.

It can be beneficial if said stiff structure can carry the vibrational signal without significantly warping it (e.g. trying to attain a sound signal from a guitar string by measuring its longitudinal forces rather than its transverse ones, will result in a warped signal, because said forces (as well as motions) are nonlinearly related), It can also be beneficial if the damper is significantly linear (having a significantly linear force-vs-velocity function curve starting from x=0 and y=0).

Said diaphragm comprises one, or more, layer(s) that separate a first and second air (gas) mass, where a pressure difference between said air masses keeps said layer(s) taut continuously (without momentary gaps). Said diaphragm layers comprise a substantially airtight layer and a substantially stiff (i.e. not stretchable, but possibly flexible) layer (where said layers may, or may not, be the same layer).

Also, the enclosing walls of an inflatable resonator/bass-trap/NSD need to be substantially stiff-against-tension since we can't rely on the mass of said walls to keep the internal volume from fluctuating with each soundwave, (although if a free-standing diaphragm is large enough that a soundwave can't easily go around it, then there may not be a need for an enclosure).

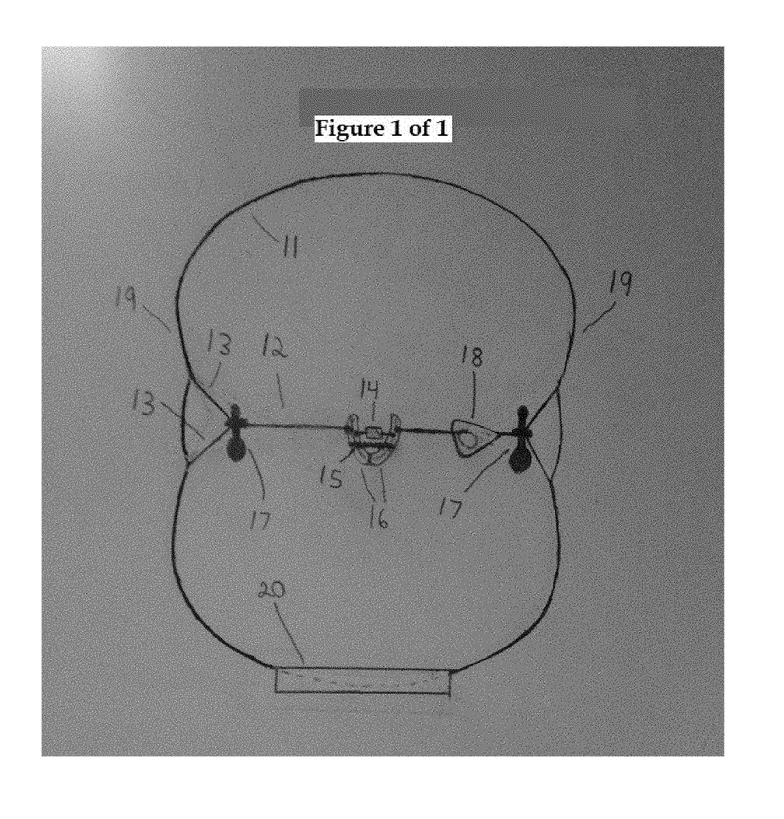

One embodiment is an inflated sphere (see FIG. 1. and its DESCRIPTION OF DRAWING) (its surface held taut due to the, relatively small, pressure difference between the air inside and outside) having a high young's modulus, and a tension member assembly connecting the front of said sphere to the back of said sphere, where said tension member assembly is, perhaps, thirty percent shorter than the sphere diameter, thus deforming the sphere, and where said tension member assembly is mostly comprised of material(s) having a high young's modulus, except for some high compliance springs at its center, said high compliance springs allow the front, and also, the back of said sphere to act as compliant diaphragms that can vibrate when exposed to low frequency sound.

The said high compliance springs comprise a primary spring that connects the front half and the back half of said tension member assembly, said primary spring is connected alongside a tiny damper, and serves to keep said damper from being extended to its maximum while allowing said damper to damp the vibrating front, and back, of the sphere. The primary spring and tiny damper are actually connected to the front half and back half of said tension member assembly by way of a set of levers, so by manually, or automatically, repositioning any of the force (contact) points on said levers, impedance can be adjusted, (see description of possible other mechanisms for adjusting leverage, above).

Adjusting the damper's position on said levers will affect the damping impedance, but the best way to adjust the resonant frequency is by changing the effective mass of the front and back of the sphere, (it may be beneficial if the back has more mass than the front, but not by much, the back will be somewhat affected in part by the large soundwave wrapping around it, who's effects may be amplified by the walls nearby, and the sides of the sphere won't vibrate because of its high stiffness (young's modulus)).

Here are two ways to—manually or automatically—change the effective mass, of the front, and back, of said sphere, without actually physically adding/removing mass, one is by using a, short, very stiff, rod that has a heavier weight on one end and a lighter weight on the other end, one can see that tightening a vibrating clamp onto different points on said rod will have the effect of applying different amounts of mass to said vibrating clamp, by making said rod act as a lever (see description of possible other mechanisms for adjusting leverage, above) (the clamp will need to be allowed to pivot slightly, so it will benefit from being supported by multiple tension members, as described earlier).

Another way to—manually or automatically—change the effective mass of the front and back of the sphere, without actually physically adding/removing mass, is by using a very stiff rod, perhaps three inches long, with only a light weight on one end, one can see that by applying two clamps to said rod, one three-inches from said weight, and the other two-and-a-half-inches from said weight, where one clamp is stiffly connected to the vibrating front of said sphere, and the other clamp is stiffly connected to the vibrating back of said sphere, the sphere can be made to resonate as though significant amounts of mass were added to both its front and back (i.e. the light mass at the end of the rod has been significantly amplified due to leverage, it's similar to connecting the front and back, of the sphere, by way of a flywheel), (said rod can be held in an orientation that is perpendicular to the forces of the tension member assembly, by way of a compliant spring that can be anchored to almost anything).

All of the said impedance adjusting components, can have markings on them, that may correspond with an instruction booklet, telling the user exactly how to adjust to achieve different results in different situations, e.g. how to achieve a specific resonance frequency, and Q, when in front of a solid wall.

Besides the, above specified, primary spring, the tension member assembly may also comprise a secondary spring, where said secondary spring is perhaps five or ten times more compliant than the primary spring (e.g. being very long, but coiled up, perhaps inside of a pully wheel that it is designed to turn), so that it will pick up most of the slack when the sphere shrinks (by as much as, perhaps, twenty percent or more) due to barometric change and slow air leakage etc., where said secondary spring cannot respond to fraction-of-a-second vibrations because it engages through a flywheel (a mass that is amplified by leverage) that slows it down. Since said shrinking of the sphere will cause a slight increase in the resonant frequency, it may be beneficial to implement a mechanism (using techniques described above) that will make leverage adjustments to the mass as the sphere's size changes.

Said sphere may have an air-valve and/or an inflating system similar to that of an air-mattress and/or an opening that allows it to be filled up quickly, perhaps with a hair dryer (on the cool setting), it may have a large opening so that a user may also reach inside and make adjustments, it may also have a transparent section that acts as a window for the user to be able to see inside, said openings may be in the form of a flexible neck (sleeve shape), resembling the opening in a standard rubber balloon, only perhaps longer, said neck may be rolled or folded before being clamped shut, the inside of said neck may contain a rubbery layer that can act as a gasket to prevent air leaks. Said neck may even contain a tapered stretchable section making it possible for the user to reach inside the sphere while the tapered stretchable section hugs said user's arm, thus not allowing air to escape. Another option to keep the air from leaking when making manual adjustments inside the sphere, is to attach a glove to the sphere's surface, as is done in laboratories when handling dangerous substances, said glove may also be rolled or folded and clamped when not in use.

The embodiment, comprising said sphere, was chosen here because it is an easy example to illustrate, but a bass-trap/resonator would fit better in corners, or between furniture if it had flatter sides, and if it had more length than width. Here are a couple of ways of making the sides flatter and/or giving it a unique shape, one, is by adding internal stiff tension members, some of the techniques used in making inflatable cartoon characters, for parades and such, may be borrowed from, but it is important to keep the system stiff so that all, or much, of the energy that is temporarily stored in the contractions/expansions of the internal volume of air, will be directed through the dedicated impedance system(s) (e.g. the dampers, the springs and masses etc.). A bass-trap/resonator may even be designed to double as an air mattress.

Adding some stiff nonflexible sections can also help shape the bass-trap/resonator, ideally these stiff nonflexible parts can be foldable, or collapsible, when the bass-trap/resonator is deflated. To maintain volume stiffness, the outer, stiff-against-tension, but flexible, surfaces should, preferably, not be dented i.e. pushed in, during use, even by the floor underneath, because when the air pressure changes, the bass-trap/resonator may simply move a little, thus changing the internal volume.

One advantage of making the damper very small, is that it can then, cheaply, be made from the best materials. The damper may take a form that is similar to any larger damping system, e.g. it may take the form of a tiny automobile shock-absorber, and/or it may comprise a sponge-like substance, perhaps soaked in a viscous liquid, and wrapped in a flexible outer layer, or it may even take the form of a simple strip of plastic, where said plastic strip replaces both the damper and the adjacent spring.

The damper(s) should have enough surface area so that it doesn't become too hot to function, but it may easily occupy thousands (if not millions) of times less volume than the entire bass-trap/resonator while still having access to practically all of the sound energy that gets temporarily stored in the contractions/expansions of the body of air that is trapped by said bass-trap/resonator, however I don't want to limit my claims more than necessary, so what follows are a few points to help define some quantities that I may use in my claims:

The amount of energy, that an inflated bass-trap, can absorb at a given frequency, where said bass-trap is significantly smaller than, about, one quarter of a wavelength, is limited only by the sound pressure, and the compliance of the bass-trap, i.e. there is no drop in pressure due to there not being enough external air to fill any gap resulting from the bass-trap's compliant shrinkage, so said bass-trap can be compared to a circuit that is connected to a power supply that has a limited voltage, but an unlimited current, and the compliance of the air that fills the bass-trap can be compared to a capacitor that is in series with the rest of said circuit. A resonating resonator, depending on its Q, (and a NSD as well) may need to be significantly thinner than a quarter wavelength if it doesn't want to run out of external—pressurized—air, but it may still be quite big.

The behavior of damping elements, compliance elements (springs), and mass elements, are well known in the art, and their similarities to resistors, capacitors and inductors are also well known in the art, additionally the physical properties of each of these elements can be very easily defined mathematically, so a very simple computer program can easily emulate any one of thousands of likely arrangements of said elements.

There exist several inflatable-sound-absorber patents, some of these inflatable sound absorbers are partially filled with conventional sound absorbing materials, and their main reason for being inflatable is to add instant structure to hold the sound absorbing materials in place, but unless stated otherwise, any references, below, or in my claims, to inflatable sound absorbers, or their absorption characteristics, refer to the inflatable portions only, e.g. any reference to their volume refers to their inflated volume minus their deflated volume.

The following are a few improvised terms, and their meaning, that may be used in my claims, hopefully this will allow me to avoid very long and complicated sentences in said claims:

“All-volume-energy” means all the sound energy that is temporarily stored in the contractions and expansions of a, free (i.e. if any sound absorber enclosing it, was removed), body of air of a given volume, at a given sound pressure level, note that only a device that resonates, or that uses negative stiffness, can exceed this limit of absorption, this is because the sound pressure level inside of said device can be a lot greater than the sound pressure level outside of said device;

“Nonresonating-absorption” means the sound energy that the inflatable portion of a given inflatable bass-trap or resonator would hypothetically absorb, for a given sound pressure level, if said bass-trap's or resonator's mass had little effect, i.e. the bass-trap or resonator weighed as much as air, i.e. the bass-trap or resonator couldn't resonate, and only the bass-trap's or resonator's compliance-impedance and damping-impedance were affecting its damping ability, this value can vary with frequency;

“Actual-absorption” means the sound energy that the inflatable portion of a given inflatable bass-trap or resonator actually absorbs, for a given sound pressure level, this value can vary with frequency.

Some of what may be claimed include:

1. An apparatus comprising at least one damping member, and also comprising a structure, where said structure comprises a substantially airtight layer that separates a first and second air (gas) mass, where said first air mass is enclosed in a substantially airtight enclosure, and where a pressure difference between said air masses keeps said layer taut, where said structure and layer can gather, and transfer, low frequency (below 500 Hz) sound energy, by way of substantially stiff solid matter, towards said damping member.

2. The apparatus of claim 1, where said damping member damps more of said frequency sound energy than its size would allow if not for said structure.

3. The apparatus of claim 1, further comprising at least one lever that is connected to said stiff solid matter in a manner that it must vibrate with said stiff solid matter at said frequencies.

4. The apparatus of claim 1, further comprising a mechanism that allows leverage adjustments to be made that will affect its sound impedance, where impedance refers to any of damping-impedance, compliance-impedance, mass-impedance, or any combination thereof.

5. The apparatus of claim 4, further comprising convenient means for a user to reach inside with a hand to make adjustments.

6. The apparatus of claim 1, further comprising a lever, or leverage system, that links two opposing sides, of said apparatuses, to the same mass, affectively adding mass to both said sides so that said sides may resonate off each other (due to also being elastically joined), without needing to be connected to anything else.

7. The apparatus of claim 1, where said damping member has a greater, compliance to longitudinal-size ratio, than does the structure that gathers and transfers the sound energy to it, no matter how a sensible jury might agree to measure it, where longitudinal-size means its size in the dimension longitudinal (parallel) to the force vector acting on it, and where damping member compliance is a measure of the damping member's own compliance as well as the compliance of any of its possible adjacent supporting structures that must comply when said damping member complies, e.g. a spring that may be connected alongside the damping member to keep it from overextending.

8. The apparatus of claim 1, where said damping member has an at least four times greater, compliance to longitudinal-size ratio, than does the structure that gathers and transfers the sound energy to it, no matter how a sensible jury might agree to measure it, where longitudinal-size means its size in the dimension longitudinal (parallel) to the force vector acting on it, and where damping member compliance is a measure of the damping member's own compliance as well as the compliance of any of its possible adjacent supporting structures that must comply when said damping member complies, e.g. a spring that may be connected alongside the damping member to keep it from overextending.

9. The apparatus of claim 1, where said apparatus is inflatable and where its inflatable portion's “Nonresonating-absorption” (as this term is defined in the specifications) is greater than six-percent of the “All-volume-energy” (as this term is defined in the specifications) of a free body of air of equal size, for at least one frequency in the range between 15 Hz and 200 Hz, for at least one sound pressure level in the range between 65 dB and 125 dB.

10. The apparatus of claim 1, where said apparatus is inflatable and where its inflatable portion's “Nonresonating-absorption” (as this term is defined in the specifications) is greater than twelve-percent of the “All-volume-energy” (as this term is defined in the specifications) of a free body of air of equal size, for at least one frequency in the range between 15 Hz and 200 Hz, for at least one sound pressure level in the range between 65 dB and 125 dB.

11. The apparatus of claim 1, where said apparatus is inflatable and where its inflatable portion's “Nonresonating-absorption” (as this term is defined in the specifications) is greater than twenty-two-percent of the “All-volume-energy” (as this term is defined in the specifications) of a free body of air of equal size, for at least one frequency in the range between 15 Hz and 200 Hz, for at least one sound pressure level in the range between 65 dB and 125 dB.

12. The apparatus of claim 1, where said apparatus is inflatable and where its inflatable portion's “Nonresonating-absorption” (as this term is defined in the specifications) is greater than forty-percent of the “All-volume-energy” (as this term is defined in the specifications) of a free body of air of equal size, for at least one frequency in the range between 15 Hz and 150 Hz, for at least one sound pressure level in the range between 65 dB and 125 dB.

13. The apparatus of claim 1, where said apparatus is inflatable and where its inflatable portion's “Actual-absorption” (as this term is defined in the specifications) is greater than forty-percent of the “All-volume-energy” (as this term is defined in the specifications) of a free body of air of equal size, for at least one frequency in the range between 15 Hz and 200 Hz, for at least one sound pressure level in the range between 65 dB and 125 dB.

14. The apparatus of claim 1, where said apparatus is manufactured to be a bass-trap or resonator for absorbing low frequency sound.

15. A negative stiffness device that can absorb sound and/or reflect sound away from itself, comprising a secondary mechanism that acts to keep the negative-stiffness elements within their functional (operational) range despite barometric (and altitude) and temperature changes, etc.,

What is claimed is:

1. An apparatus comprising at least one damping member, and also comprising a structure, where said structure comprises a substantially airtight layer that separates a first and second air (gas) mass, where said first air mass is enclosed in a substantially airtight enclosure, and where a pressure difference between said air masses keeps said layer taut, where said structure and layer can gather, and transfer, low frequency (below 500 Hz) sound energy, by way of substantially stiff solid matter, towards said damping member.

2. The apparatus of claim 1, where said damping member damps more of said frequency sound energy than its size would allow if not for said structure.

3. The apparatus of claim 1, further comprising at least one lever that is connected to said stiff solid matter in a manner that it must vibrate with said stiff solid matter at said frequencies.

4. The apparatus of claim 1, further comprising a mechanism that allows leverage adjustments to be made that will affect its sound impedance, where impedance refers to any of damping-impedance, compliance-impedance, mass-impedance, or any combination thereof.

5. The apparatus of claim 4, further comprising convenient means for a user to reach inside with a hand to make adjustments.

6. The apparatus of claim 1, further comprising a lever, or leverage system, that links two opposing sides, of said apparatuses, to the same mass, affectively adding mass to both said sides so that said sides may resonate off each other (due to also being elastically joined), without needing to be connected to anything else.

7. The apparatus of claim 1, where said damping member has a greater, compliance to longitudinal-size ratio, than does the structure that gathers and transfers the sound energy to it, no matter how a sensible jury might agree to measure it, where longitudinal-size means its size in the dimension longitudinal (parallel) to the force vector acting on it, and where damping member compliance is a measure of the damping member's own compliance as well as the compliance of any of its possible adjacent supporting structures that must comply when said damping member complies, e.g. a spring that may be connected alongside the damping member to keep it from overextending.

8. The apparatus of claim 1, where said damping member has an at least four times greater, compliance to longitudinal-size ratio, than does the structure that gathers and transfers the sound energy to it, no matter how a sensible jury might agree to measure it, where longitudinal-size means its size in the dimension longitudinal (parallel) to the force vector acting on it, and where damping member compliance is a measure of the damping member's own compliance as well as the compliance of any of its possible adjacent supporting structures that must comply when said damping member complies, e.g. a spring that may be connected alongside the damping member to keep it from overextending.

9. The apparatus of claim 1, where said apparatus is inflatable and where its inflatable portion's “Nonresonating-absorption” (as this term is defined in the specifications) is greater than six-percent of the “All-volume-energy” (as this term is defined in the specifications) of a free body of air of equal size, for at least one frequency in the range between 15 Hz and 200 Hz, for at least one sound pressure level in the range between 65 dB and 125 dB.

10. The apparatus of claim 1, where said apparatus is inflatable and where its inflatable portion's “Nonresonating-absorption” (as this term is defined in the specifications) is greater than twelve-percent of the “All-volume-energy” (as this term is defined in the specifications) of a free body of air of equal size, for at least one frequency in the range between 15 Hz and 200 Hz, for at least one sound pressure level in the range between 65 dB and 125 dB.

11. The apparatus of claim 1, where said apparatus is inflatable and where its inflatable portion's “Nonresonating-absorption” (as this term is defined in the specifications) is greater than twenty-two-percent of the “All-volume-energy” (as this term is defined in the specifications) of a free body of air of equal size, for at least one frequency in the range between 15 Hz and 200 Hz, for at least one sound pressure level in the range between 65 dB and 125 dB.

12. The apparatus of claim 1, where said apparatus is inflatable and where its inflatable portion's “Nonresonating-absorption” (as this term is defined in the specifications) is greater than forty-percent of the “All-volume-energy” (as this term is defined in the specifications) of a free body of air of equal size, for at least one frequency in the range between 15 Hz and 150 Hz, for at least one sound pressure level in the range between 65 dB and 125 dB.

13. The apparatus of claim 1, where said apparatus is inflatable and where its inflatable portion's “Actual-absorption” (as this term is defined in the specifications) is greater than forty-percent of the “All-volume-energy” (as this term is defined in the specifications) of a free body of air of equal size, for at least one frequency in the range between 15 Hz and 200 Hz, for at least one sound pressure level in the range between 65 dB and 125 dB.

14. The apparatus of claim 1, where said apparatus is manufactured to be a bass-trap or resonator for absorbing low frequency sound.

15. A negative stiffness device that can absorb sound and/or reflect sound away from itself, comprising a secondary mechanism that acts to keep the negative-stiffness elements within their functional (operational) range despite barometric (and altitude) and temperature changes, etc.
